(19) United States
(12) Patent Application Publication
(10) Pub. No.: US 2002/0158166 A1
(43) Pub. Date: Oct. 31, 2002

(54) Device for precaution skyjacking and system

(76) Inventor: Zhen-Man Lin, Kowloon (HK)

Correspondence Address: RABIN & BERDO, P.C., Suite 500, 1101 14th Street N.W., Washington, DC, 20005, US

(21) Appl. No.: 10/029,951

(22) Filed: Dec. 31, 2001

(30) Foreign Application Priority Data
Feb. 25, 2001 (CN) 01255903.2

(51) Int. Cl. B64D 11/00; B64D 13/00

(52) U.S. Cl. 244/118.5

(57) ABSTRACT

This airliner hijacking prevention system solution is the most sophisticated solution available today. The solution consists of the following three complementary, indispensable parts:

1. The double-door “single person checkroom”, the only passage to the cockpit. In this closed one-person-only checkroom a series of checks are made before access is gained to the cockpit.

2. Closed circuit television and communication system, hidden, free from the control of the aircrew, and with independent power supply. This system keeps informed of what is going on in the cabin.

3. A hidden flight locus monitor free from the control of the aircrew and with independent power supply also transfers messages between the airliner and the ground monitoring center through a relay satellite or special frequency band.

### BACKGROUND OF THE INVENTION

1. Field of the Invention

The present invention relates to newest device for precaution skyjacking and system.

2. Description of the Prior Art

The suicide terrorist attacks on World Trade Center and Pentagon with huge civil airliners astonish and infuriate the world. “Are we safe?” is a question raised by the people of Hong Kong as well as USA, whose enormous economic loss is shadowed by inner grief.

Sorrow and anger are condensed into the words “Punish the terrorists!”. “Prevent hijacking!” is a paramount task of governments in the future! Sorrow and anger inspire American people to tide over difficulties with the government! Although airports have resumed service, stricter check makes people even more anxiety-ridden. “Are we safe?” is a persistent question. The Empire State Building, overwhelmingly magnificent and believed to be the tallest in New York now, is likely to be deserted by salary earners. Skyscrapers are now, expectedly and painfully, choking the life of economy . . . .

US stock exchange is to open on Monday, the shares of insurance companies involved will fall into disfavor. Skyscraper syndrome will also entangle real estate shares . . . . Arrows shot from the dark are beyond our capability to escape from. Who is dominating the world now? The current terrorist crisis tests the intelligence of US leaders, not America's military power. It is but common imagination, not Bush's insight, to spot the harbor of terrorists and get even with them. Airports are now under stricter control, but is there anybody who can guarantee our safety and reassure us? How can anxiety-ridden people push economy forward? US president Bush has a bucket of sticky problems to tackle!

How the New York Stock Exchange will behave when it resumes operation can measure the extent to which the world is affected by the century disaster. What is essential is how to convince people that such a disaster will not occur again? People expect President Bush to come out to assure them before the Stock Exchange resumes operation:

“We have found a plan to prevent hijacking. We will issue, discuss and carry out the plan! The strict and unpleasant check at airports is expected to ease after the plan is implemented. The pain is temporary because we are powerful in our production and technological capabilities. The disaster will never happen again! The people of the United States and around the world will no longer live in the shadow of terrorism! May the victims of the disaster rest in peace. We'll let terrorists know that human civilization is not to be trespassed upon!”

The world is waiting. And we strongly believe that the above four plans are effective in preventing hijacking by improving the structure of the airplane and setting up corresponding procedures. It is reported that people working in the Empire State Building feel quite upset because of their being “outstanding”. Acrophobia is spreading! Without plans to end hijacking, the shares of airlines, insurance, real estate and tourism will fall into disfavor. Fear will lead to economic turbulence and downturn. We expect President Bush to come out with strong measures and assure people that all evils will be conquered!

The unprecedented disaster heralds the beginning of the life-and-death struggle between the evil and the civilized community. With a sense of mission, the inventor faxed the creative hijacking prevention device and system proposal as well as the above background materials to Mr. Liu of USA Embassy in Hong Kong on Sep. 19, 2001, warded them to the white house and President Bush.

At four o'clock on Sep. 26, 2001, Mr. Liu told the inventor over the phone: “I would like to thank you on behalf of the government of USA . . . ” On Sep. 27, 2001, President Bush aired three safety measures for civil aviation. Mr. Bush will expectedly take resolute actions to implement these measures and launch a campaign to conquer the evil! In the above Proposal to President Bush on Four Hijacking Prevention Solutions, solutions II and III are combined into one. President Bush made some revisions and came up with the three safety measures for civil aviation.

On Oct. 22, 2001, the Patent Bureau of China finished the international patent ion report concerning the application for the patent of “Measures on the Prevention Hijacking of Civil Airliners”. This report lists six successful cases and the originality that a patent technique should have. It is these six cases that set off not only the originality of this patent but also its flawlessness!

The reference numbers of the six cases in the Inspection Report are listed below:

| | | | | Request | |
|---|---|---|---|---|---|
| | Rela- | | | for | International |
| | tivity | Country | Reference No. | rights | patent No. |
| 1 | Y | CN | A,85100918, B64CA/14 | 1-3 | B64 |
| 2 | Y | CN | A,1126686, B64D25/00 | 1-2 | B64 |
| 3 | Y | CN | A,1038434, B64D25/00 | 1-2 | B64 |
| 4 | Y | US | A,3704845, B64C 1/10 | 1-2 | B64 |
| 5 | Y | JP | A,9-036791, H04B7/15 | 3 | B64 |
| 6 | Y | JP | A,9-020297, B64D47/00 | 3 | B64 |

1. Patent No. CN 85100918A

Patent owner: Mr. Yi Ming and Mr. Shen Xinhua of Mashan Surveying and Mapping Team, Jinxian County, Jiangxi Province.

Patent name: Airliners with Anti-Hijacking Function Dec. 20, 1985

What is claimed is:

The following three major technical features of this invention are to be patented.

1. Walls and doors with new functions: using new materials to make the walls and doors capable of sustaining heavy impacts and gunfire.

2. Two different types of “Safety cockpit” designed to prevent hijackers from entering the cockpit, thus ensuring normal flight of the airliner.

3. Alarm device designed to keep people informed whether the safety door of the cockpit is open or closed.

The first technical feature is designed in light of the following:

(1) Using bulletproof high-performance materials to make isolating boards.

(2) Double-bar-shaped, spear-shaped and blade-shaped screws designed to fix the isolating boards and prevent hijacking.

(3) External framework with “metal blades” designed to fix the isolating boards and prevent hijacking. Aluminum alloy materials shaped like knives or saw-teeth, giving the “metal blades” extra power.

The second technical feature is designed in light of the following:

(1) Safety isolating walls with no doors and permanent safety cockpit.

(2) Transit room and impermanent safety cockpit.

(3) Transit room technique including how to enter the cabin from the cockpit and vice versa.

The third technical feature is designed in light of the following:

(1) Alarm device used to keep aircrew informed whether the doors of the cockpit and cabin are open or closed. The alarm device may consist of indicator, flashlight and buzzer.

(2) Spring switches designed to connect or disconnect some circuits according as whether the safety bolts are plugged or unplugged.

(3 Synchronized switches designed to make the alarm device automatically operate when the airliner is started.

2. Patent CN 1126686A

Patent owner: Mr. Wang Honghua, Shangyuetang Construction Section, Zhuzhou City, Hunan Province, 412000

Patent name: Airliner Anti-Hijacking System, Jan. 12, 1995

What is claimed is:

The application of Mr. Wang Honghua is basically the same as No. 88103336.7 patent CN 1038434A of Mr. Zhang Hua and Mr. Zhou Guangyuan of Beijing. This invention adopts automatic monitor to transfer messages, but it is installed only in the airliner. The inventor treats the airliner full of passengers as the battlefront.

1. The inventor designs to install the alarm device in the cockpit, but fails to explain how the alarm device identifies hijackers.

2. He points out that “digit-key alarm device” is now available in China, explains how the alarm device can exactly count the hijackers, how many cameras are needed to cover every corner of

the airliner, how to identify overlapped images, and how to spot disguised hijackers. The 0˜9 keys are intended to notify the control (operation) room to press 6 or 7 when 6 0 7 hijackers are counted. Then what about 11 hijackers? The story is not convincing first because of the irrational design of the alarm device!

3. The inventor designs to equip the plane with auto-aim guns that are synchronous with the small video cameras, transferring messages to the control room. His patent invention does not ensure the safety of the hostages. Auto-aim technique is rather complicate. The “anti-hijacking” function claimed by the inventor will fail if the hijackers hold just one hostage or makes a smoke screen.

3. Application 88103336.7 CN 1126686A

Patent owner: Mr. Zhang Hua

Address: No. 8, Bldg. 2, behind Yong An Dong Li Primary School, Jian Guo Men Wai, Chaoyang District.

Patent name: Anti-Hijacking Device Installed on the Aircraft Jan. 3, 1990

What is claimed is:

TV monitor, striker, gun barrel and gun head on the operation desk designed by the Beijing inventor can't prevent hijacking. They are just mechanical or shooting devices, which can do nothing when terrorists hold any hostage. Patent 88103336.7 CN 1126686A is by no means the same as Mr. Zhen-man Lin hijacking-prevention solution.

4. Application U.S. Pat. No. 3,704,845, B64C 1/10

Patent owner: Michael Ord, 5267 Wilkins Avenue, Pittsburgh, Pa. Dec. 5,1972

Patent name: AIRPLANE HIJACKING PREVENTION SYSTEM

Abstract of disclosure:

A method and system for preventing airplane hijacking features the following:

1. The cockpit is isolated from the cabin to give passengers a sense of safety, but communication must be ensured. The buttons fixed in the cabin keep the cockpit informed of such things as oxygen shortage, fire alarm, medical accident, device fault and any other trouble.

2. The isolating door between the cockpit and the cabin is restricted, and the door and its associated isolating walls are made of bulletproof materials.

3. The voice communication system of the audio system is a one-way system from the cockpit to the cabin, preventing the words of the hijackers from being heard.

4. This invention warns the passengers in advance.

The key idea of the patent is that the pilots are locked in the cockpit so that the hijackers cannot communicate with the pilots. Even if the hijackers hold any hostage, the pilots will not open the cockpit without hearing anything. Even if the hijackers do as indicated in FIG. 4 22, the pilots may choose to stay if the situation is not critical.

5. Application JP,A,9-036791, H04B7/15

(19) Franchise Office of Japan (JP) Issued on Feb. 2, 1997

Inventor: Decheng Changzhi

Address: No. 1 Bldg. 1 Dingmu 2, Xiaogu, Hanchuanding, Gaozuo Shire, Kanagawa

Patent name: A Support Device Using Satellite Communication to Prevent Hijacking

The inventor designed the support device using satellite communication to prevent hijacking. The device keeps the ground monitoring center informed of what is going on in a hijacked airliner by means of satellite communication.

Solution:

In case of hijacking, the passengers or aircrew press the emergency buttons fixed at various places in the airliner, the video camera with long or short lens installed at an appropriate place begins to work, digitizes the information by means of an image processing device or turns the information into FX (facsimile) file format, and then sends the information to the ground monitoring center via the satellite. The ground monitoring center in turn sends information via the satellite to the camera so that the camera adjusts the foci and angles of the long and short lens. In addition, dialogs may help to solve hijacking.

What is claimed is:

1. Fix several cameras at places with a good field of vision and install a monitor in the cockpit to monitor the cabin, and receive information from the communication satellite and transfer it to the ground monitoring center through the support device.

2. Record the information of the satellite for the use of the emergency communication device. Use the image processing device to digitize the information or turn the information into FX (facsimile) file format and then send it to the ground monitoring center.

3. Fix emergency buttons in the cockpit and the cabin, which serve to start the support device so that the ground monitoring center can monitor what is going on.

6. Application JP,A,9-020297, B64D47/00

(19) Franchise Office of Japan (JP) Issued on Jan. 21, 1997

Inventor: Youdong Gongqi

Address: No. 1, Zhizituju 1467, Zuoboding, Zhedao

Patent: Support Device for Hijacking Prevention

Application JP,A,9-020297,B64D47/00 is exactly the same as JP,A,9-036791, H04B7/15. It is strange that both of them should be approved. Both use satellite communication to achieve the same purpose. Both are different from the hijacking prevention system. Item 3 of Mr. Zhen-man Lin hijacking prevention system solution features a detailed and original arrangement for remote control of the airliner. Therefore we can easily come to the conclusion that application JP,A,9-020297,B64D47/00, just like JP,A,9-036791, H04B7/15, cannot prevent the generation of Mr. Zhen-man Lin hijacking prevention system solution.

### SUMMARY OF THE INVENTION

The disadvantages of prior art are overcome by the present invention, following is their disadvantages and solutions from the present invention:

the features of CN 85100918A include the following:

1. Shockproof isolating walls with or without doors, featuring bulletproof materials (unidentified yet) and heterogeneous screws fixing isolating boards.

Comments: Over one hundred years' development of aircraft leads to different performance concepts of isolating-wall technique and bulletproof performance. This patent technique is open to all aircraft manufacturers.

2. Permanent doorless design or entering impermanent safety cockpit through the “transit room”.

Comments: Application for patent does not depend on failure or success of permanent doorless design. The safety conditions of the “transit room” are monitored through a peephole. The right of passage through the “transit room” is subject to the perception of the aircrew, which is a time-honored concept! What is strange is that the most recent application for patent was made in 1985, but there weren't the sophisticated automatic detection tools already available in the 1970s, so that patent CN85100918A lacks the originality essential to any patent! The inventor has further modified the design from double-wall double-door to double-wall three-door (FIG. 9). Short of automatic detection tools, however, more doors are of no avail! A knife is enough for the terrorists to force the aircrew to take them through the “transit room” to the cockpit! Therefore, no one has used patent CN85100918A. The inventor is fully aware of that and so identifies his invention as impermanent design.

3. The third patent feature of CN85100918A is the alarm device designed to keep people informed whether the safety door of the cockpit is open or closed.

Comments: Page 7 highlighted by the patent staff: (1) The alarm device consists only of indicator, flashlight and buzzer. It serves to notify whether the doors are properly closed. But the then popular infrared sensor is not used, how could such an alarm device be sophisticated? (2) The safety lock is even more outdated. It is intended to lock the door of the cockpit, with the key to be kept by captain. What the terrorists need to do is steal the key (without needing to kill the captain) and enter the cockpit. (3) The shield of the peeping device is intended to prevent terrorists, who may look into the cockpit through the peephole, from shooting at pilots. If the terrorists are determined to shoot, chain switches may serve the same purpose. In addition, convex lens widely used in stores and shops may better serve the purpose. Therefore, using shield is like carrying coals to Newcastle!

Patent CN85100918A is defective. The 19^{th}-century technology was not to blame for its inability to prevent hijacking. The scarcity of practical anti-hijacking techniques sets off the originality of this patent technique. For example, image identifier, identification through sound spectrum, and use of five-finger mold instead of that of a single finger. The application of this patent system solution will help eradicate “hijacking”!

Patent CN1126686A may be virtual, but it does not befit a civilized society to turn an airliner into a battlefield. Unlike patent CN1126686A, which features “anti-hijacking”, Mr. Zhen-man Lin patent focuses on the prevention of hijacking, therefore his patent application is justifiable.

Patent 88103336.7 CN 1126686A is by no means the same as Mr. Zhen-man Lin hijacking-prevention solution. Having been widely used, TV monitor is not a patent but an auxiliary method. It is not key to Mr. Zhen-man Lin patent solution to hijacking prevention. It does not befit a civilized community to ignore the safety of passengers and turn an airliner into a battlefield. Therefore Mr. Zhen-man Lin application 8810336.7 is not truly valid.

Drawbacks of U.S. Pat. No. 3,704,845, B64C 1/10

1. The US patent invention does not allow for any possible neglect of the pilots.

2. The pilots may not come even if all buttons in FIG. 4 22 are pressed.

3. Are the bulletproof wall and door of the cockpit soundproof? The hijackers know perfectly well how to raise hell, and they will kill one person every five minutes until the pilots come out!

5. The pilots may rely on their unreliable perception and reasoning to decide whether to open the door of the cockpit, therefore the US patent invention is inadequate to deter hijacking.

The US patent invention in 1972 has drawn upon the experience of the previous three patents of China but still leaves much to be desired. By contrast, the double-door structure specified in Mr. Zhen-man Lin patent is original, the “Single-person checkroom” is a natural evolution of modem technology, and the five-finger mold is unprecedented. The single-person checkroom of the double-door structure precludes the effect of human factors and the five-finger mold makes the system flawless. The hijacking prevention system of Mr. Zhen-man Lin is so original that the US patent application does not affect the patent application of Mr. Zhen-man Lin.

As the name implies, the invention is a support device to prevent hijacking through satellite communication! The idea is good enough but not specific yet. Its merit is the support device used for negotiation and monitoring!

It is recommended in Item 3 of Mr. Zhen-man Lin hijacking prevention system solution that, apart from using satellite communication for negotiation and monitoring, manual piloting should be disabled while automatic piloting enabled until the airliner touches down, thus deterring hijacking. There lies the originality of the invention! Satellite communication is not the patent right of application JP,A,9-036791, H04B7/15, but instead the right of the owner and inventor of the satellite! What makes the difference is how to use satellite communication to achieve different purposes. Item 3 of Mr. Zhen-man Lin hijacking prevention system solution features a detailed and original arrangement for remote control of the airliner. Therefore we can easily come to the conclusion that application JP,A,9-036791, H04B7/15 cannot prevent the generation of Mr. Zhen-man Lin hijacking prevention system solution.

Application JP,A,9-020297, B64D47/00 is exactly the same as JP,A,9-036791, H04B7/15. It is strange that both of them should be approved. Both use satellite communication to achieve the same purpose. Both are different from the hijacking prevention system. Item 3 of Mr. Zhen-man Lin hijacking prevention system solution features a detailed and original arrangement for remote control of the airliner. Therefore we can easily come to the conclusion that application JP,A,9-020297, B64D47/00, just like JP,A,9-036791, H04B7/15, cannot prevent the generation of Mr. Zhen-man Lin hijacking prevention system solution.

Obviously, the present invention provides not solutions of problems of prior art, but newest and most safe device for precaution skyjacking and system!

### BRIEF DESCRIPTION OF THE DRAWINGS

FIG. 1 is a graph that shows profile of hijacking prevention system and device.

FIG. 2 is a flow chart of airliner hijacking prevention system.

FIG. 3 is a program block diagram of single person checkroom security system.

FIG. 4 is a graph that represents construction of a series of security checking system.

### DETAILED DESCRIPTION OF THE PREFERRED EMBODIMENTS

A. Improvement of Airplane Structure and Establishment of Corresponding System Program

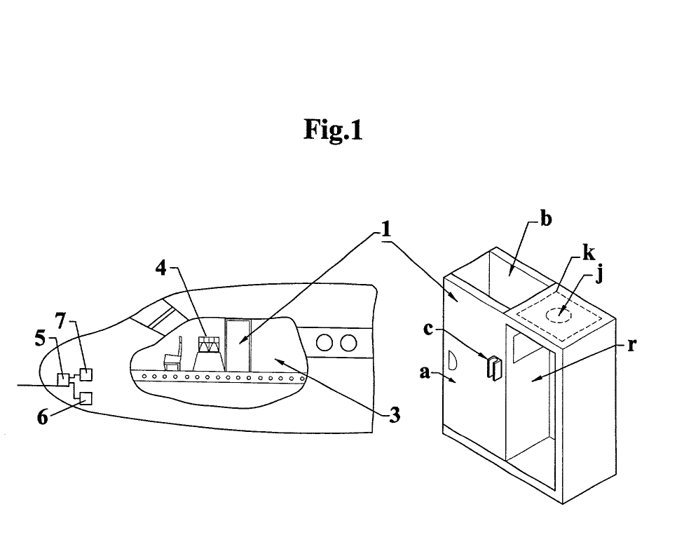

1. As shown in FIG. 1-1, install “Single person checkroom” path structure to make it impossible for terrorists to enter the cabin. The structure of checkroom must in order to precaution against that to bump and to pick out of.

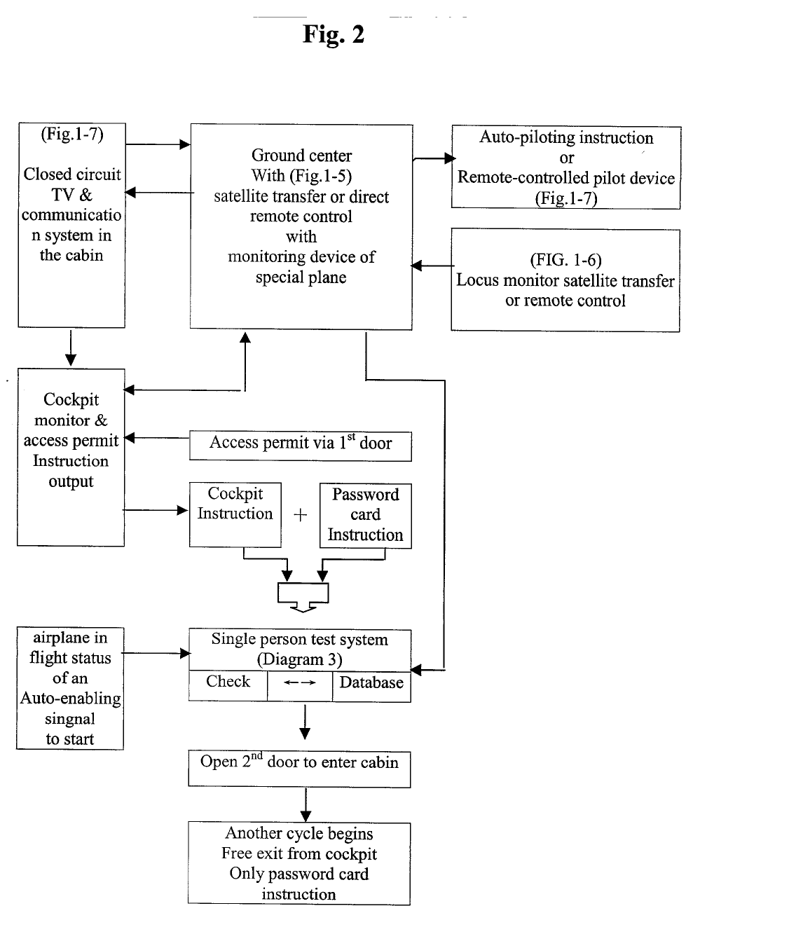

2. As shown in FIG. 2 of the systematic program, install independent concealed electronic monitoring device not controllable by but visible to the aircrew. Special waveband transfer enables ground-based monitoring center to have full control of terrorists and negotiate with them easily.

3. As shown in FIGS. 1-3, at the four passages of the entrances of the airliner, install remote-controlled chemical spraying guns and appropriate obstacles to control or restrict the activities of terrorists.

4. As shown in FIG. 2, nothing is worse when the pilot takes a hand in hijacking, but in this case “flight locus calibrator” can be used to lock flight course, under the remote control of ground-based monitoring center.

5. As shown in FIG. 2, the ground-based monitoring center has special plane with monitoring device, ready to fly and trace. Or satellite relay stations may transfer monitoring messages.

6. Set flight discipline for the aircrew.

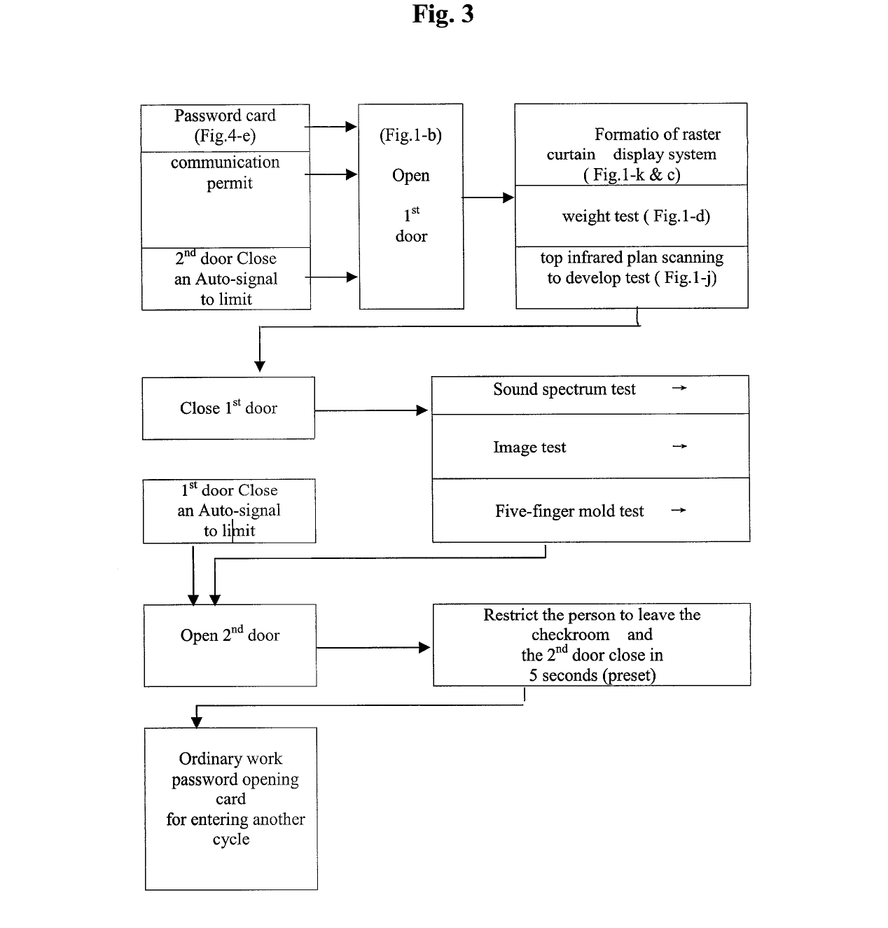

B. FIG. 3 is shown, applications of Facilities and Features of System Program:

(1) Add passage checkroom structure and system setting:

a. FIG. 1-a & b. are shown, install unidirectionally transparent bullet-proof glass door from the cabin to the passage as a second door, so that the pilot can see the passage unidirectionally, making hijackers conscious of someone looking at them in the dark.

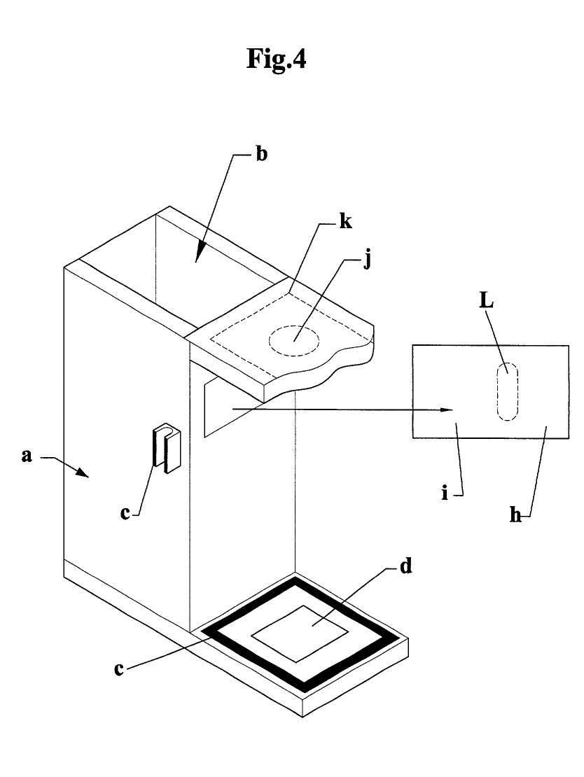

b. As shown in FIG. 4a & b, the back and front panels of the bullet-proof glass door are both unidirectionally transparent, with 0.8˜1-meter single person checkroom in between, FIG. 4c. is shown a detector of raster curtain; FIG. 4d. is shown identifying weight; FIG. 4e. is shown a detector of password card; FIG. 4h. is shown a detector of Five-finger mold test; FIG. 4i. is shown a detector of Image test; FIG. 4j. is shown a detector of human body infrared; FIG. 4k. is shown a launcher of special beams; FIG. 4 l. is shown a detector of voice recognition; they will be automatically identifying weight, password card, fingerprint, image and voice test.

c. As shown in FIG. 2, the front and back panels are closed under the double control of closing instructions of airplane in flight status and ground-based monitoring center, meanwhile turning on the automatic identifier.

d. FIG. 2. is shown, aircrew must get permission via communication and password card instruction to open the first door and enter the checkroom, and the automatic identifier, after sensing only one person in the checkroom, closes the first door and begins to check.

e. As shown in FIG. 3, after the automatic identifier checks single person only and makes ID identification, the cabin, on being notified of the ID of the approaching person, decides whether to open the second door. The first door will not open until the second door closes, thus preventing hijackers from swarming in.

f. Persons in the cabin will be documented by the captain and monitoring center respectively when the automatic identifier is started. There must be at least one engineer in the cabin, otherwise no person can pass the checkroom, except in non-flight status of the plane or by obtaining instruction from the monitoring center.

g. If any person in the cabin wants to leave the cabin during flight, a simple password card can be used to open the second door and enter the checkroom, and the automatic identifier in the checkroom instructs to close the second door and begins to check. The first door can be opened only after the check.

h. The automatic identifier sets the number of persons in the cabin and decides that at least one engineer must stay in the cabin during flight.

i. Problems and solutions:

1. The automatic identifier restricts the number of persons in the checkroom, making it impossible for hijackers to enter the checkroom together with the aircrew. A hijacker may only enter under disguise, but the automatic identifier may have identification combinations, such as the weight, fingerprint and palm print and voice. The unidirectionally transparent glass door fully exposes hijackers, but it is necessary to equip back-view mirror for the engineer or formulate review system to increase the weight of manual check.

2. Why use the five-finger mold? Because a single finger may be cut, but if the whole hand is cut, it will be impractical and unnecessary to use modem technology to make a frozen cut hand resume its original appearance in the short time and limited space. This makes the system flawless.

3. Even if the engineer and aircrew are hijackers, who can freely pass the Single person checkroom, they are restricted by 2.(3) Lock flight course by means of flight locus calibrator.

(2) Independent concealed electronic monitoring device:

The historic disaster of World Trade Center shows how defective the designs of airplanes are: the hijackers shut down all communications facilities so that their identities remain a mystery. The black box cannot provide real-time on-site video and audio recordings, making it almost impossible to find and punish those behind the terrorist acts.

As shown in FIG. 1-4, the airplanes are not equipped with independent concealed video and audio electronic monitoring equipment and real-time transfer and storage equipment, which (if any) cannot be controlled by the aircrew. This is ridiculous today, when technology is so sophisticated and the space is studded with satellites.

No doubt, the US aviation security bureau cannot pass the buck.

Therefore, it is imperative that independent concealed electronic monitoring device should become a standard device of an airliner. Some people may claim that their privacy is encroached upon, but the monitoring on the channel is within the permitted range. And so the independent concealed electronic monitoring device may somewhat deter potential hijackers.

(3) Lock flight course by means of flight locus calibrator:

a. As shown in FIG. 2, in case the flight locus deviates from the preset course, the calibrator (FIG. 1-6) will surely use the alarm functions of channel feedback center of the electronic monitoring device.

b. With flight locus calibrator, the ground-based monitoring center may switch manual steering over to remote-controlled automatic/semiautomatic steering (not beyond the present technology) when the engineer loses his right to act.

c. It is advisable to draw upon the high-air remote control technology of air scouts. The security of a hijacked plane may somewhat be affected by geographical and atmospheric conditions, but “remote control” can bring the hijacked plane to “an automatic flight status” and thus absolutely prevent the plane from suicide attack on downtown areas or landmark buildings. For example, the plane can be made to safely rise and fly away from the downtown area and enter into “remote-controlled steering status”, thus winning time for the plane to enter the preset course. Decades of successful applications of automatic pilot have made us fully convinced of its security.

d. Confidentiality of remote control information is no problem in today's digitized age.

(4) The ground-based monitoring center has special plane with monitoring device, ready to fly and trace. The ground-based special remote-controlled plane prevents an accident plane from flying out of the direction radius.

(5) Set flight discipline for the aircrew:

a. It is necessary to strictly comply with the discipline set by the structure and program of the channel calibration room so as to preclude any hijacking.

b. Make the engineer more capable of tackling emergencies mainly with portable non-fatal chemical weapons.

From the description above shows the excellence and characters of the present invention:

1. The Measure Plan of this patent centers on structural techniques;

2.Various combinations of available classifiable techniques are used in the Measure Plan;

3.The Measure Plan is quite comprehensible. Except the remote-controlled which are encrypted, all the rest is open to the public, thus serving as an effective deterrent to hijackers;

4.Even though the above Measure Plan leaves much to be certified and improved, it comes right to the point if considered from the perspective of the global economy;

5.It is likely for the Americans to accept the plan, because they have their own thoughts and judgements! They will regain confidence in safety and overcome their fears incurred by the disastrous attacks. The global economical order is soon to return to normal!

The use and networking of “flight locus monitors” of the monitoring centers at airports the world over promise enormous business opportunities. Uprooting hijacking, striking terrorism worldwide and defeating the evil by enlightened means manifest the intelligence of the civilized human community.

The present invention has been described with a preferred embodiment thereof and it is understood that there is not restriction to the type of the present invention, many changes and modifications in the described embodiment can be carried out without departing from the scope of the invention which is intended to be limited only by the appended claims.

What is claimed is:

1. Airliner hijacking prevention system solution program consists of the following:
a. The double-door “single person checkroom” is the only entrance to the cockpit;
b. The cockpit and the ground monitoring center continuously monitor the cabin through the concealed electronic monitoring devices, forming a deterrent to potential hijackers;
c. With the flight locus monitor, the ground-based monitoring center may switch manual steering over to remote-controlled automatic/semiautomatic steering when the engineer on the airliner loses his right to act.

2. Airliner hijacking prevention system solution program as claimed in claim 1, wherein said “Single person checkroom” is the only entrance to the cockpit, and the two doors are opened and closed according to the preset program.

3. Airliner hijacking prevention system solution program as claimed in claim 1, wherein said the double-door, that is, the front and back doors of the “single person checkroom” are equipped with unidirectionally transparent bulletproof glass, shockproof plastic or naked eye viewing window.

4. Airliner hijacking prevention system solution program as claimed in claim 1, wherein said “single person checkroom”, which with preset program and closed space, one or more identification means such as weight, image, voice, fingerprint or ID number can be used to the determine of right of passage.

5. Airliner hijacking prevention system solution program as claimed in claim 4, wherein said fingerprint identification mean, that is, “five-finger mold”, which helps the single person checkroom make identification almost unmistakably.

6. Airliner hijacking prevention system solution program as claimed in claim 4, wherein said the identification of a single person in the “single person checkroom” is confined to the raster curtain.

7. Airliner hijacking prevention system solution program as claimed in claim 1, wherein said the “electronic monitoring device” can be connected to the narcotic guns installed at the cross-shaped passages of the four entrances of the plane.

8. Airliner hijacking prevention system solution program as claimed in claim 1, wherein said the system transfers messages between the airliner and the ground monitoring center through a relay satellite or special frequency band, and continuously monitors the cabin through the concealed electronic monitoring device.

9. Airliner hijacking prevention system solution program as claimed in claim 1, wherein a remote-control plane is prepared; when said ground monitoring center could not control the airliner normally due to poor coverage of communication signal, said remote-control plane takes off and controls said airliner.
